(19) United States
(12) Patent Application Publication
(10) Pub. No.: US 2025/0225573 A1
(43) Pub. Date: Jul. 10, 2025

(54) TRUPREDICT SYSTEM AND METHOD OF OPERATING THE SAME

(71) Applicant: Incucomm, Inc., Addison, TX (US)

(72) Inventors: Samuel Vasta, Addison, TX (US); James Robinson, Plano, TX (US); Ricardo Lopez, Grand Prairie, TX (US); James Ruedlinger, Forney, TX (US); Steven Roemerman, Highland Village, TX (US); Eric Haney, Dallas, TX (US)

(73) Assignee: Incucomm, Inc., Addison, TX (US)

(21) Appl. No.: 18/942,309

(22) Filed: Nov. 8, 2024

Related U.S. Application Data
(63) Continuation of application No. 15/929,385, filed on Apr. 29, 2020, now abandoned.
(60) Provisional application No. 62/839,934, filed on Apr. 29, 2019.

(51) Int. Cl. G06Q 30/08; G06Q 10/0875; G06Q 30/0283

(52) U.S. Cl. CPC G06Q 30/08; G06Q 10/0875; G06Q 30/0283

(57) ABSTRACT

An apparatus, system and method for producing a bid price for a service or a good. The apparatus is configured to determine market pricing of an offering derivable from a labor pricing model to estimate a cost of a service, or derivable from a bill of materials model to estimate a cost of a good; determine strategic pricing of the offering derivable from a likelihood of an action being taken and a magnitude of pricing change if that action occurs; determine a competitor evaluation of the offering capturing a view of a customer towards each competitive offering along factors that may incorporate factors beyond solely cost; and aggregate the market pricing, the strategic pricing, and the competitor evaluation to produce a bid price for the offering to win a competition within a confidence interval.

This application is a Continuation of U.S. patent application Ser. No. 15/929,385 filed on Apr. 29, 2020, entitled “TRUPREDICT SYSTEM AND METHOD OF OPERATING THE SAME”, which claims the benefit of U.S. U.S. Provisional Patent Application No. 62/839,934, entitled “TruPredict,” filed Apr. 29, 2019, which are incorporated herein by reference.

### FIELD OF THE INVENTION

The present invention is directed, in general, to computational analytics and, in particular, to a system and method for producing a bid price for a service or a good.

### BACKGROUND

The definition of “Price-to-Win” (also referred to as “PTW”) is the price at which an organization will likely win a business competition based on how all competitors are evaluated by the buyer (or customer) with both price and non-price factors taken into consideration. Price-to-win is also shorthand for the process and professional function of evaluating competitions. This field has grown in popularity as the push for data-driven decision-making has increased, especially in markets where competitions may be worth millions or billions of dollars.

Therefore, it is desirable to define an approach that accurately assesses the factors to win a competition that can deal with the full range of uncertainties of a bidding process.

### SUMMARY

These and other problems are generally solved or circumvented, and technical advantages are generally achieved, by advantageous embodiments of the present invention for an apparatus including processing circuitry and for a method configured to determine market pricing of an offering derivable from a labor pricing model to estimate a cost of a service, or derivable from a bill of materials model to estimate a cost of a good; determine strategic pricing of the offering derivable from a likelihood of an action being taken and a magnitude of pricing change if that action occurs; determine a competitor evaluation of the offering capturing a view of a customer towards each competitive offering along factors that may incorporate factors beyond solely cost; and aggregate the market pricing, the strategic pricing, and the competitor evaluation to produce a bid price for the offering to win a competition within a confidence interval.

The foregoing has outlined rather broadly the features and technical advantages of the present invention in order that the detailed description of the invention that follows can be better understood. Additional features and advantages of the invention will be described hereinafter, which form the subject of the claims of the invention. It should be appreciated by those skilled in the art that the conception and specific embodiment disclosed can be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention and the advantages thereof, reference is now made to the following descriptions taken in connection with the accompanying drawings, in which:

FIG. 1 illustrates a block diagram of an embodiment of a method to produce a competitive bid decision;

FIG. 2 illustrates a block diagram an embodiment of components of the TruPredict system;

FIG. 3 illustrates a block diagram illustrating example components of the market pricing subsystem of FIG. 2;

FIG. 4 illustrates a block diagram illustrating example components of the strategic pricing subsystem of FIG. 2;

FIG. 5 illustrates a block diagram illustrating example components of the competitor evaluation subsystem of FIG. 2;

FIG. 6 illustrates a block diagram illustrating example components of the price-to-win subsystem of FIG. 2;

FIG. 7 illustrates a graphical representation of an embodiment of a price-to-win curve showing the dependence of a bid amount on a probability of winning;

FIG. 8 illustrates a histogram illustrating an embodiment of cost score and non-cost score as components of a total score for one's own corporation and a competitor;

FIG. 9 illustrates a diagram showing an embodiment of receiving qualitative statements relating to non-cost factors;

FIG. 10 illustrates a screenshot showing an overview of strategic pricing motivators represented on a dashboard which can be comprehended and addressed quantitatively to a competitive bid;

FIG. 11 illustrates a graphical representation showing example price outcomes of two competitors for a given bid amount;

FIG. 12 illustrates curves representing example probabilistic outcomes of two competitive offerings for a given bid amount;

FIG. 13 illustrates an example of decomposition backward of total offering score into its constituent parts; and

FIG. 14 illustrates a schematic view of an embodiment of at least a portion of an apparatus employable to run the TruPredict system.

Corresponding numerals and symbols in the different figures generally refer to corresponding parts unless otherwise indicated, and will not be redescribed in the interest of brevity after the first instance. The FIGUREs are drawn to illustrate the relevant aspects of exemplary embodiments.

### DETAILED DESCRIPTION

The making and using of the present exemplary embodiments are discussed in detail below. It should be appreciated, however, that the embodiments provide many applicable inventive concepts that can be embodied in a wide variety of specific contexts. The specific embodiments discussed are merely illustrative of specific ways to make and use the systems, subsystems, and modules associated with a system and method that provide a bid price for an offering in, for instance, a commercial market.

A system will be described herein with respect to exemplary embodiments in a specific context, namely, a broad class of commercial systems configured to produce a bid price for an offering of a good or service. The specific embodiments of an apparatus including processing circuitry and for a method configured to determine market pricing of an offering derivable from a labor pricing model to estimate a cost of a service, or derivable from a bill of materials model to estimate a cost of a good; determine strategic pricing of the offering derivable from a likelihood of an action being taken and a magnitude of pricing change if that action occurs; determine a competitor evaluation of the offering capturing a view of a customer towards each competitive offering along factors that may incorporate factors beyond solely cost; and aggregate the market pricing, the strategic pricing, and the competitor evaluation to produce a bid price for the offering to win a competition within a confidence interval. The principles of the present invention are applicable to processes of support in many fields including, but not limited to, manufacturing and other commercial activities.

A price-to-win as described herein, is inherently multi-domain, subjective, and full of uncertainty. Price-to-win performs the practice and professional function to determine what an organization needs in a competitive bidding process to win a bid for a good or service. This can be a professional service to integrate various perspectives from a competitor's view, from an company executive's view, and include elements learned from prior bidding efforts. An automated work-flow process guides a user through the steps of constructing a price-to-win to enable a bidding decision to be made. The outcomes ultimately drive the success and failure of modern organizations-if they are not able to successfully secure new business or are not able to secure business at a price which returns adequate profits, an organization is likely to struggle. Therefore, it is of the utmost importance that organizations accurately assess what is required to win a competition in the face of these complexities.

An approach will be introduced herein that accurately assesses the factors to win a competition and that can deal with multi-domain, subjective, and plural uncertainties of a bidding process. In order to perform a price-to-win analysis, organizations currently use a range of tools from very general analytics tools (e.g., Excel®) to very specific cost estimating tools. These tools vary in their capability to produce standardized outputs, to facilitate consistent approaches, to provide a structured system for analysis, or include a range of outcomes. Most existing tools also do not explicitly include characteristics of other competitors in their analysis-instead, focusing solely on their own organization's pricing.

Once a baseline cost estimate is produced, business development, capture management, and executive personnel often influence the price downward in an effort to win the competition. This can reflect subjective knowledge of the customer's buying tendencies, the competition evaluation criteria, or expected bids by competitors. Introduction of these subjective biases into the strategic pricing creates uncertainty in how an organization will bid as well as how competitors and evaluators will react—but these uncertainties are not well covered by current systems, tools and processes.

Price-to-win analysis may include uncertainty in order to be accurate—the practitioner is estimating a future price to deliver their solution, compared against an unknown group of competitors, and judged by a group of customers with their own internal biases. However, some current approaches do not include mathematical uncertainty in their calculation, instead defaulting to deterministic inputs and results. Others include uncertainty, but are cumbersome to use, use advanced experience with statistics, or effectively limit the size of the analysis due to computational requirements.

Therefore, a methodology that provides a repeatable, consistent, transparent, and auditable price-to-win system that allows for efficiency in training, development, and delivery of standardized deliverables to internal and external decision-makers. This can facilitate faster, less expensive, higher quality bids and more flexible business capture approaches.

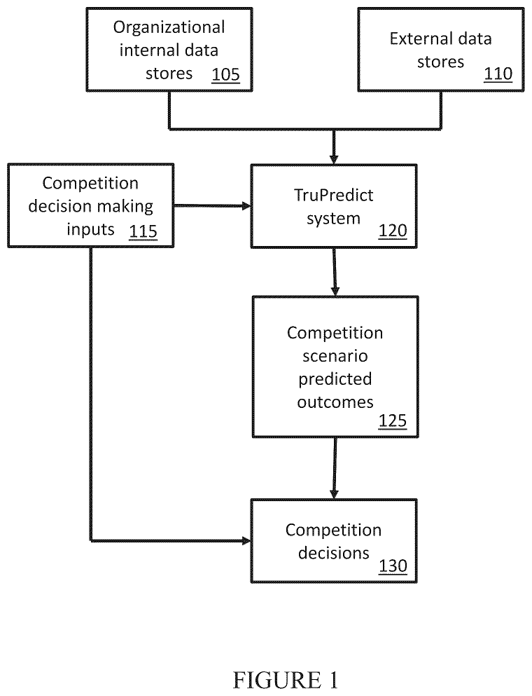

Turning now to FIG. 1, illustrated is a block diagram of an embodiment of a method to produce a competitive bid decision. As illustrated in FIG. 1, organizational internal data stores 105 and external data stores 110 provide market pricing data, strategic pricing data, and competitor evaluation data to a price-to-win system (also referred to a “TruPredict system”) 120. In a subsystem 125 a competition scenario is employed to predict a bid outcome. In a subsystem 115, competition decision-making inputs are fed to the TruPredict system 120 and to the competition decision subsystem 130. The competition decision subsystem 130 produces competition decisions.

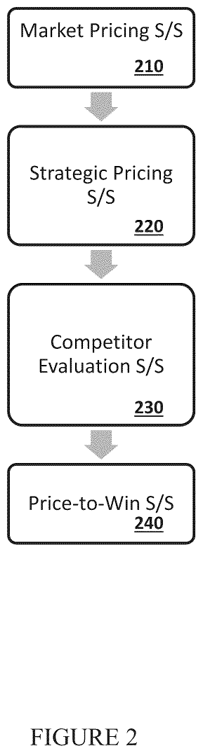

Turning now to FIG. 2 illustrated is a block diagram an embodiment of components of the TruPredict system. The TruPredict system includes a market pricing subsystem (“S/S”) 210 to quantify what the offering should cost the customer without any discounts. This may include differentiating the market pricing between your organization and competitor organizations. The market pricing of an offering is derivable from a labor pricing model to estimate a cost of a service, or derivable from a bill of materials model to estimate the cost of a good. The market pricing can also take into account a baseline cost estimate of the offering. The labor pricing model and the bill of materials model may be derived from a deterministic estimation or uncertain estimation. The labor pricing model and the bill of materials model are broken into constituents where information is more available.

A strategic pricing subsystem (“S/S”) 220 takes the market pricing and applies strategic adjustments that reflect an organizations tendencies, incentives, and biases. The strategic pricing of the offering is derivable from a likelihood of an action being taken and a magnitude of pricing change if said action occurs. The strategic pricing captures positive and negatives incentives that influence a bid decision.

A competitor evaluation subsystem (“S/S”) 230 breaks down how the competitors will be judged by the customer. This involves quantifying what matters to the customer and how each competitor is viewed by the customer. The competitor evaluation of the offering captures a view of a customer towards each competitive offering along factors beyond solely cost. The competitor evaluation typically includes a plurality of competitors and alternatives from the competitors. The competitor evaluation may include past projects, recent bid wins and losses, press releases, job postings, changes in leadership, financial filings, and corporate conference calls.

A price-to-win subsystem (“S/S”) 240 aggregates the information collected in the previous subsystems to determine likely winners of the competition and their bid prices. If uncertainty has been included in the analysis, this will result in quantitative probability of win for each competitive offering. Thus, the price-to-win subsystem 240 aggregates the market pricing, the strategic pricing and the competitor evaluation to produce a bid price for the offering within a confidence interval. The confidence interval provides a likelihood of winning a competition for the bid price, and/or a risk of losing a competition, and what other offering will likely win, for the bid price. The price-to-win subsystem 240 may employ a Monte Carlo analysis to produce the bid price by recalculating the bid price a plurality of times.

No unambiguous system currently exists that represents the above multi-domain, subject and uncertain elements in a consistent, repeatable format. Therefore, a system that provides technology-enabled structure of price-to-win analysis as set forth above would be advantageous to a wide range of business functions. It would facilitate the standardization of the price-to-win process around researched best practices, perform rapid “what-if” scenario analysis in real-time, and include accurate uncertainty modeling.

The overall scope of the process illustrated herein is centered on decisions within a competitive bidding process. Within this process, there are some individual(s) with the task of offering a selected good or service at a specific price to a customer. They can incorporate any knowledge they have about their own goods and service (represented in FIG. 1 by subsystem 105), any knowledge they have about competitors good or services (represented in FIG. 1 by subsystem 110), and knowledge they have about the customer's expectations of the good or service (represented in FIG. 1 by subsystem 115). Examples of these data inputs include, but are not limited to, material pricing lists, labor rates, titles and geography of job postings, financial filings, past bidding history, organizational budgets, strategic initiatives of the competitor, strategic initiatives of the customer, organizational structure, individuals personality traits, organizational tendencies, and past/current/proposed books of business.

All of these types of inputs, some of which may be quantitative, other qualitative, some of them known exactly, others conveyed with uncertainty, are ingested into the TruPredict system 120 via a manual loading process (via a keyboard or other input device to a computer) or through direct data connections. The TruPredict system 120 may be hosted on a local computer, on an organizationally-hosted server, or through a cloud-based system—these latter options offer the capability to rapidly share inputs and results thereof to many distributed users and has substantial benefits, but may be subject to advanced cybersecurity restrictions for some instances. The primary output of the TruPredict system 120 is the prediction of how a competition is likely to play out (competition scenarios predicted outcomes 125 within a confidence interval) given the input assessments and data provided to the TruPredict system 120.

The user of the TruPredict system 120 can ultimately interpret the results of the process and, along with their individual and organizational motivations, come to a discrete conclusion of what good or service to offer and at what price to offer it to a customer. This decision (competition decision 130) is directly influenced by accuracy of the underlying process, the quality and uncertainty of data surrounding the competition, competitors, and customer, and the risk tolerance of the decision-making individual(s) interpreting the results.

Price-to-win analysis is decomposed into four primary elements, each with their own unique data requirements, assumptions, and best practices. As the system progresses from market pricing through the price-to-win, the amount of information provided becomes more holistic of the actual outcomes of the competition. At a high-level consider the following complexity and knowledge of each element. The market Pricing subsystem 210 takes into account knowledge of an organization's capability to deliver a contract for a given price. Depending on the contract, this may include some combination of goods and services. These may be broken down further into contract line items (“CLINs”), a bill of materials (“BOM”), labor pricing, or other items depending on the specific contract requests and/or the availability of that level of detailed data. In order to calculate market pricing for an external competitor's offering, the same categories of data may be used-however less detail and more uncertainty may be expected when compared to an organization's internal pricing data.

The strategic pricing subsystem 220 takes into account knowledge of competitors' price discounting tendencies with respect to the specific competition being considered. This can come from an organization's history with competitors, a concerted competitive intelligence effort, analysis of competitor's bids, analysis of bids within a market segment, or some combination of the above. Example competitive intelligence may include mining an organization's past projects, recent bid wins and losses, press releases, job postings, changes in leadership, financial filings, and corporate conference calls. There is significant insight buried in public information, especially when aggregated together into a structured strategic pricing system.

The competitor evaluation subsystem 230 takes into account knowledge of both the customer and the contract. Traditionally, price-to-win is often performed once a formal request for proposal (“RFP”) has been released by the customer. This will often come with an explicit or implicit discussion of the evaluation criteria. In the case of U.S. government contracts this will be contained in Sections L and M of an RFP. The system then makes a determination of how the customer views each competitor in relation to the evaluation criteria. These determinations are often subjective and include some level of judgement about the technical capabilities of each offering or which each competitor may have one or more. This assessment should also include the overall standing of competitors in the eyes of the client.

The price-to-win subsystem 240 takes into account knowledge of an organization's appetite for risk. Once the range of likely bids is laid out for each competitor's offering, it is up to system to lay out the risk, upside and probability of win (the confidence interval) for a specific bid price. As an organization's bid price is lowered, the likelihood of winning the competition will increase, but potential profits will decrease. At some low bid amount, it may be challenging for an organization to deliver such a solution with the assumed profit margins and overhead structure. Conversely, as an organization's bid price is increased, the likelihood of winning the competition decreases, but the profits that will be produced will increase. While it is up to the organization to ultimately determine the best mix of probability of win (“PWin”) and price, the proposed system provides a holistic and quantified estimation of the range of outcomes.

It should be noted that degree of fidelity (or even inclusion) of each element in the overall TruPredict system is open to user interpretation. This may include using different approaches for uncertainty, providing aggregated estimates for total contract/contract item/sub-contract item cost, ignoring or estimating strategic influencers, or any other approach that limits the fidelity of the answer, but eases the user workload. This flexibility allows the same core system to be used for quick, efficient analysis for initial estimation of whether a project is worth pursuing, as well as in-depth line-by-line analysis filled with substantial competitive intelligence and domain knowledge embedded for honing a final bid amount. Although the first approach may take less than an hour to configure and run and the latter may take months to properly define, they both positively impact an organization's business processes. In addition, by providing a unified system to perform a continuum of fidelity, consistency, understandability, and reusability of work products is enforced.

Advantageous functionality includes extensible, standardized data interfaces for both system inputs and system outputs. These support live, periodic, and manual exchanges of data between TruPredict system and external applications—this allows the system to interact with existing accounting, business capture, decision-making, and other supporting software systems. Additionally, the system architecture is developed in a platform agnostic structure—i.e., the same TruPredict system can be executed on a local, shared organization server, cloud or other compute infrastructure which can reflect the scale, scope, security, and other requirements of the organization.

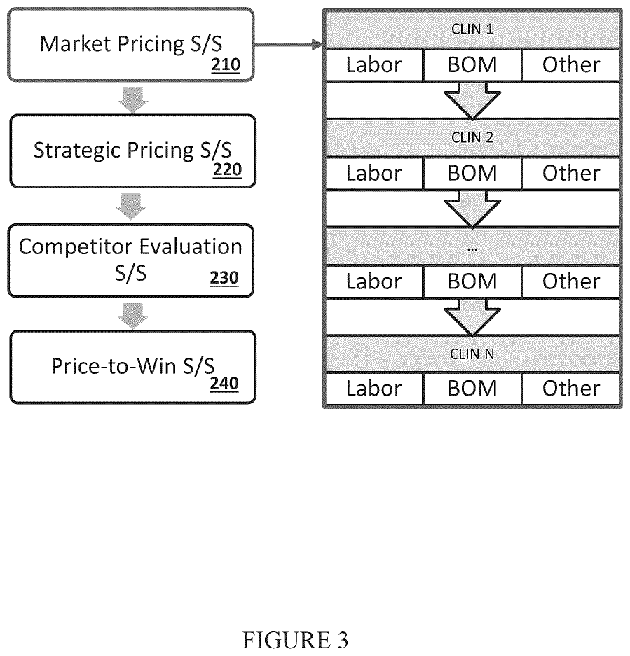

Turning now to FIG. 3, illustrated is a block diagram illustrating example components of the market pricing subsystem 210 of FIG. 2. The market pricing can depend on labor, a bill of materials (“NOM”) and other factors to form a plurality of contract line items (CLIN 1, . . . , CLIN 4).

The market pricing subsystem 210 quantifies what the offering should cost the customer without, for instance, any discounts. This step may include differentiating the market pricing between an organization and competitor organizations. There are several options, amongst others, which are available for calculating a contract line item (CLIN 1, . . . , CLIN 4) or sub-line item (“SLIN”). The top line market pricing employs the overall contract amount for a given competitor/offering. This approach can be beneficial if the contract is not overly complex, or little detailed information about an offer is known.

Aggregated market pricing is a bottoms-up approach where the contract is broken down into smaller line items that are then aggregated to form a total market price. Each line item or sub-line item can be represented by several modeling concepts. Constant value assumes the line item price is exactly known and has no uncertainty around its pricing. Uncertainty range asks the user to estimate the range of prices for a given line item. This reflects the variation in possible outcomes (i.e., the one in ten chance when things go well/poorly). Uncertainty may be reflected through absolute, relative, symmetric or asymmetric variance strategies, amongst others.

A pricing matrix provides the user a table of quantity bins and requests a price per unit for each bin. The requirement to use a pricing matrix and its associated bins are often directed by the customer and are prevalent when the quantity of purchased items is not known a priori. Labor model calculates the line item from a specified number of labor hours. Other inputs around the labor code (productivity, cost per hour, wrap rates, etc.) are taken into account for this modeling approach which should be known to those skilled in the art.

There is also the possibility to link to other contract items as a means of calculation. In this context, link refers a specific item to any other calculated item in the model. This approach can be very useful when contract items are dependent or items are best represented as multiples of a known value (i.e., supplier A's price is typically 20% higher than supplier B's price). Links are dynamic-if the upstream calculation is edited, the downstream linked value will automatically adjust.

Any of the above may also be developed by means of internal or external connection through a standardized data interface. This includes, but is not limited to, third party sources of data, supplementary analysis and modeling tools, other TruPredict solutions, domain expert elicitation results, pre-defined competitive intelligence content packs, internally or externally stored templates for common contract items, information developed from web scraping, on-demand competitive intelligence support, among others or as a combination of methods and data sources.

The TruPredict system provides real-time Monte Carlo analysis of each offering's market price. As each line item is given a price or its pricing model is edited, the TruPredict system is automatically re-calculating the overall price. This means each line item is being independently estimated a multitude of times, aggregated across any contract groupings, and summed up to the calculate the full range of outcomes in the market price. This approach-which can extend to real-time Monte Carlo recalculation throughout the remaining price-to-win system—allows the system to provide real-time feedback of the impact, with uncertainty, of changing individual inputs. Typical Monte Carlo trial sizes are between 1,000 and 50,000 independent trials—as the trial size increases the evaluation variance reduces, but at the cost of computational overhead. This tradeoff will be understood by those skilled in the art.

One approach to summarizing the results of market pricing (and other pricing results) across their simulated Monte Carlo outcomes is with an ensemble of percentile values. Other approaches including different percentiles, statistical moments, and other statistical calculations are also embodied. Table 1 below illustrates probabilities of a price point.

TABLE 1
Pricing Likelihoods

| Name | Math Description |
|---|---|
| Possible Low | 1 in 10 chance the price could be this low |
| Likely Low* | 3 in 10 chance the price could be this low |
| Normal | Most likely price. Equal chance to be higher or lower |
| Likely High* | 3 in 10 chance the price could be this high |
| Possible High | 1 in 10 chance the price could be this high |

*Not used in all summaries for conciseness

Several other features with the market pricing subsystem 210 system allow the analysis to be tailored to a specific engagement. These inclusions are based off price-to-win best practices and first-hand knowledge of potential needs within the analysis system. CLIN groups allows the user to associate line items and sub-line items together for reporting purposes. This can be useful when there are categories of goods or services being provided and/or multiple years of offerings are required.

Customer provided flags allow a line item that is specified by the customer to be included in the overall scope. Included in evaluation flags allows line items to be included/excluded from the price-to-win analysis. This allows a line item's data to still be captured, but reflect that is not considered by the client when making the competitive selection. Quantity set excursions allow the user to test market prices for different quantities of products/services, listed as CLINs or SLINs in the RFP, that the customer may require. This is especially useful for indefinite delivery indefinite quantity (“IDIQ”) style contracts where exact quantities are not known before the contract is awarded.

A capability to transform total cost, line item cost, or sub-line item cost by some mathematical transformation function for quick analyses. Typical uses of this functionality would be to multiply the resulting line item by a scalar or adding a constant value to the result in order to understand the sensitivity of a price-to-win on the underlying pricing assumptions.

Automated or estimated contract item may be based on historical data analysis. This may include applying machine learning, artificial intelligence, or other data analysis techniques towards predicting the cost, quantity, technical merits, or other properties of a contract element based solely on known predictors. For example, based off similar contracts to similar customers, the price for a component is likely to be offered between $10 and $12 per unit. A similar automated estimation approach can be used for labor rates, strategic discount rates, or other contract inputs where sufficient historical data is available.

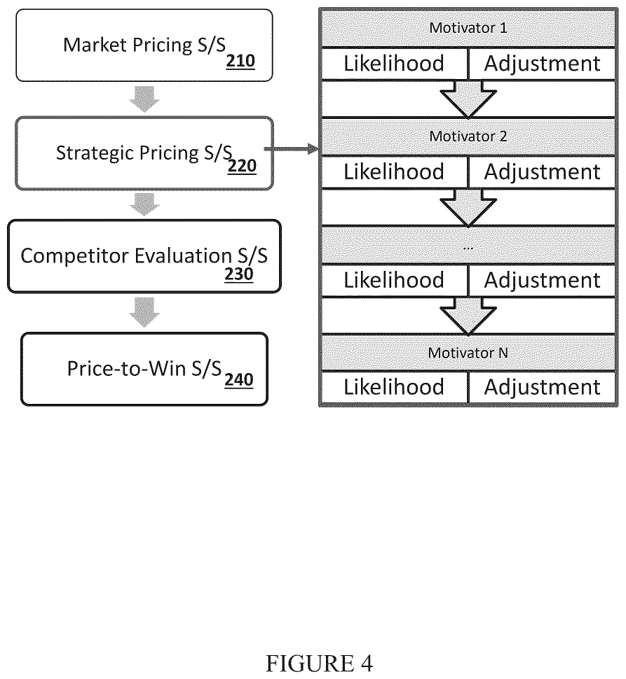

Turning now to FIG. 4, illustrated is a block diagram illustrating example components of the strategic pricing subsystem 220 of FIG. 2. The strategic pricing subsystem 220 depends on a plurality of motivators.

Offerors understand they are in a competition. They also have their own set of incentives and biases. In order to estimate how an offeror may adjust their market price, the TruPredict system uses the strategic pricing to quantify the likely adjustments an organization will make to their price during a competition in an attempt to win.

Current price-to-win approaches typically do not address price reduction, or if they do, do not systematically assess why an organization may strategically adjust their market price. In addition, price adjustments in other approaches are often done without uncertainty—i.e., the likelihood and magnitude of a strategic price adjustment by a competitor are assumed as known values.

The system introduced herein addresses these biases by drawing from aggregated research insights in the field of behavioral economics—the study of how people and organizations interact with money and competitions—and uniquely tailors them to the price-to-win environment. A behavioral economics approach differs from traditional economics which treats a dollar as a dollar as a dollar-regardless of how an organizations financial standing, personal attitudes, past relationships, or business incentives amongst others. The TruPredict system codifies this approach in order to methodically apply general behavioral economics concepts to the defined competitive bid process.

Best practices developed herein have found strategic motivators generally fall under four primary categories, however specific engagements, markets, customers, or competitions may include additional, supplementary, or different strategic motivators to capture an organization's discounting tendencies. The motivators include business base motivators, financial motivators, competition motivators and customer motivators.

In order to quantify the impact of each motivator, the TruPredict system decomposes each motivator into specific business actions that are likely to be seen in a competition. The specific questions below are one embodiment of motivators for the strategic pricing subsystem 220; however it is understood that these motivators may be adjusted to reflect a specific market, submarket, competition or other unique scenario.

The mathematical or systematic approach to quantifying each motivator, regardless of its category, is generic although its data and its impact on the final bid score may be unique. Each motivator is broken down into two numerical components percent likelihood an action is taken, and magnitude of adjustment if that action is taken (price can be adjusted up or down depending on strategy) including the range of adjustments.

The TruPredict system combines these two components mathematically to create a strategic pricing adjustment. It should be evident to those skilled in the art how two such inputs may be combined probabilistically to form a distribution of outcomes due to each motivator. Strategic motivations and their expected impact can be elicited in an unguided data entry method, through a guided questionnaire, or through other elicitation means. The source data for competitors' discounting tendencies can come from internal domain expertise, internal and external surveys, internal competitive intelligence, external competitive intelligence that may be interfaced manually or programmatically through standardized data interfaces, or other available sources of competitor and domain knowledge.

An offering may include several motivators, often overlapping organizational priorities. The TruPredict system generates the strategic adjustment for each motivator independently for each of the simulated Monte Carlo competitions and then may apply the largest calculated adjustment for that simulated competition. While this approach is preferred due to its capability to keep strategic adjustments from compounding to create unrealistic Strategic Pricing scenarios, other embodiments for combining parallel strategic pricing motivators are also encompassed.

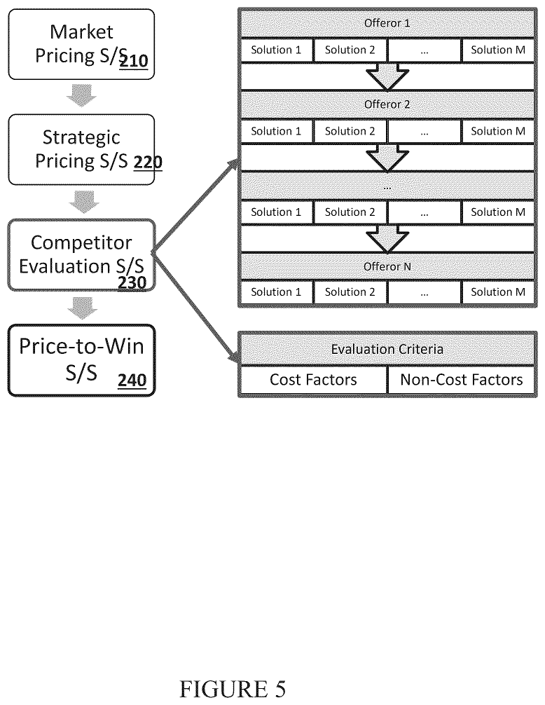

Turning now to FIG. 5, illustrated is a block diagram illustrating example components of the competitor evaluation subsystem 230 of FIG. 2. The competitor evaluation subsystem 230 depends on a plurality of offerors.

The offerors are assessed on some combination of cost and non-cost factors. Based on the particular competition, these factors and how relatively important they are may be laid out in the RFP or they may be implicit based off the customer's behaviors. The customer will combine evaluations of each offering on a cost and non-cost basis to determine an overall best value.

During the contract proposal definition process, the customer will determine how they will evaluate competitors. They will determine the evaluation metrics and their relative importance. This process includes how to weight cost and non-factors against each other. Programmatically interfacing with methods of interpreting RFP through natural language processing, machine learning or other automated or manual methods of deciphering RFP text are also comprehended.

The definition of best value may be stated directly, stated indirectly, implied or not stated at all. Because of these wildly varying scenarios, the portion of the TruPredict system should be capable of both understanding how organizations communicate priorities in natural language, as well as how priorities are expressed probabilistically within competitions. That quantified outputs for priorities may also be expressed as uncertain ranges.

Typical non-cost factors include, but are not limited to, technical capability, past contract performance, experience, program management and key personnel. For each non-cost factor, a qualitative ranking is given by the user. The default scales for qualitative ranking in the TruPredict system may be taken from the US Department of Defense Source Selection Procedures; however, other such embodiments are assumed. Once a ranking is determined for the offeror, a corresponding value or range of values is assigned automatically—the default probabilistic ranges are based on price-to-win best practices, however further customized weighting schemas are also comprehended. Once all factors and sub-factors have been rated for a given offeror, they are aggregated together to give an overall offering scores.

Other methods of determining overall value based on non-cost factors are also comprehended, e.g., technical performance above and beyond the baseline requirement reflecting a better value to the customer even if it is offered at a higher price. This approach has been referred to as VATEP by some US government agencies; however, other methods for influencing effective cost through non-cost performance are also comprehended.

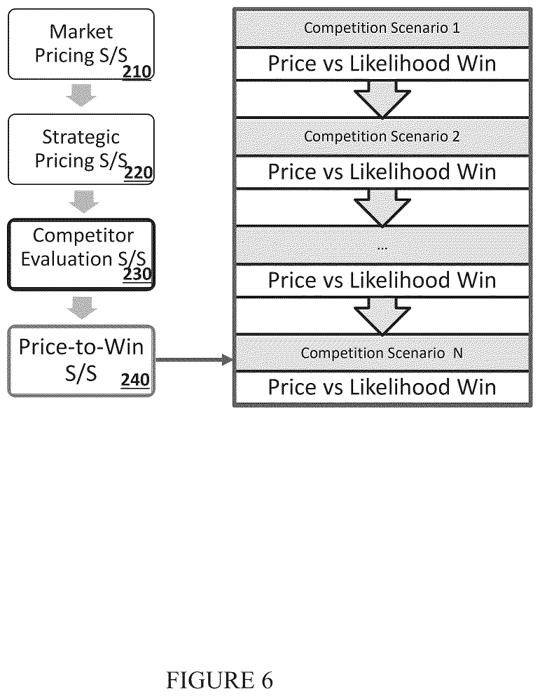

Turning now to FIG. 6, illustrated is a block diagram illustrating example components of the price-to-win subsystem 240 of FIG. 2. The price-to-win subsystem 240 depends on a plurality of competitive scenarios.

The price-to-win is the price at which an organization will likely win a competition based on how all competitors are evaluated by the buyer, price and non-price factors taken into consideration. For any given bid amount, there is a probability that the bidder will win the competition. The probability of win (“PWin”) has an inverse relationship with the bidder's price—as the price increases, PWin decreases. In most price-to-win engagements, the PWin is specified by the user and the price-to-win is the output of the process.

Organizations typically have a target PWin based on their perceived importance of the competition and their desired risk profile. A more aggressive (lower) bid amount will ensure a higher PWin, but may lower profits or be more difficult to execute. A more conservative (higher) bid amount will lower the odds of winning the competition, but will provide a more profitable engagement if won. Typical values for PWin are in the 80-90% range.

Once non-cost factors have been evaluated, the corresponding non-cost scores are not affected by bid amount. However, cost scores for each offeror will change with a varying bid amount. As an organization's bid price is decreased relative to other competitors′, their cost score will increase, their overall score will increase, their PWin will increase, and competitors' aggregate PWin will decrease.

Each probabilistic outcome is incredibly interdependent on the bid amount, evaluations, and value weighting factors of the customer—each of which contains its own uncertainty. Each offeror has a range of final outcomes for total evaluated score. This range reflects uncertainty in their pricing structure, labor rates, supplier costs, technical capability, and overall competency in the eyes of customer. The TruPredict system layers these uncertainties on top of each other to truly build a realistic simulation of the competitive outcomes. The final price-to-win is calculated after this landscape is quantified.

Competition scenarios allow the capability to layer additional assumptions on top of the price-to-win system. Different competition scenarios allow the user to compare “What-if” analyses in a structured format—i.e., what happens if a Competitor A receives a higher technical evaluation score; what happens if a Competitor B reduces their price for a specific CLIN. It is ultimately up to the user to aggregate these scenarios in their final determination of their price-to-win bid amount; however, the TruPredict system allows a unified platform in which to compare these disparate scenarios.

In addition to pricing element changes, the competition scenarios may be used to vary any number of system inputs throughout the TruPredict system. This includes contract item structure, contract item pricing, contract item pricing uncertainty, strategic pricing likelihood, magnitude, or motivator, competitor evaluation criteria weights, competitor evaluation assessments, among other system inputs.

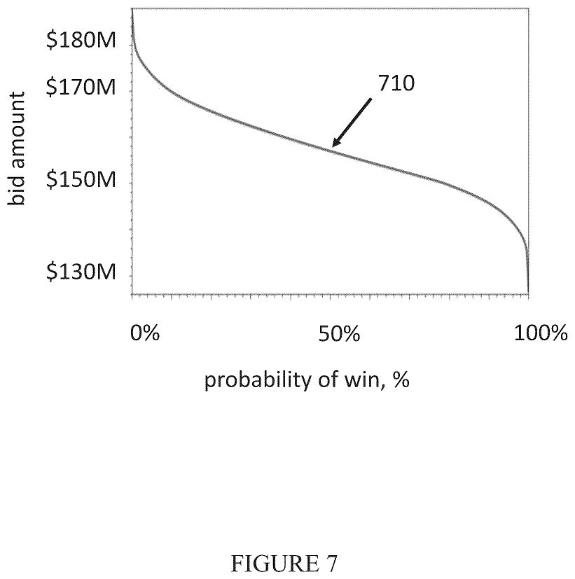

Turning now to FIG. 7, illustrated is a graphical representation of an embodiment of a price-to-win curve 710 showing the dependence of a bid amount on a probability of winning. The graphical representation illustrates a price-to-win curve 710 showing a probability of winning a competition versus a bid amount.

One of the primary results of the TruPredict system is the price to win curve 710. This relates the bid amount to the probability of win for a specific offer versus a known set of competitors. A visual representation of this relationship is shown in FIG. 7—a 0% PWin is shown on the left side of the graph when the bid amount is highest and proceeds towards 100% PWin as the bid amount decreases. This smooth curve 710 is actually a piecewise representation of multiple Monte Carlo scenarios set at a given bid amount with a smoothed spline for visual representation. No explicit definition is available for this relationship—it is implicitly defined numerically based on the outcomes of running and re-running the simulated competition.

The price-to-win curve 710 shows that if one wants to bid $180M or more, this is an admissible bid but one will not win the competition. Bidding $130M or less will result in almost always winning, but likely not profitably. A decision-maker makes a bid amount between these extreme levels that provides a reasonable probability of winning while producing a profit for the corporation. The challenge is to achieve a reasonable probability of winning a bid while taking into account technical and strategic issues, prior performances, reputations, and other cost and non-cost characteristics. The three factors of market pricing, strategic pricing, and competitor evaluation are taken into account, both for oneself and for the various competitors involved in the current building exercise.

The first step in creating a price to win curve 710 is defining the bounds of bid amount for the 0% and 100% PWin values. This involves an iterative PWin bounds search for both cutoff values. This is particularly important because bids above the 0% cutoff and below the 100% cutoff do not affect an organization's PWin-changing their bid amount will not affect the competition beyond these points. Therefore it is imperative that the TruPredict system not spend calculation resources analyzing bid amounts in these regions.

As the bid price decreases, a company's cost score will increase leading to a higher PWin. For each simulated competition, the TruPredict system is selecting the offer with the highest overall score to win that competition. This means that as a company's PWin is increasing, the PWin of the competitors is decreasing. This relationship will not be a simple one-to-one relationship in competitions with more than one offeror where interactions can be complex. However, if you sum the PWin for all competitors within a computational trial it will equal 100%, regardless of the size of the competition. It should be noted that non-cost scores play a large role in PWin-changing non-cost evaluation scores can increase or decrease PWin much more than bid price in some situations.

In order to improve computational efficiency and evaluation runtime, an approach to a plurality of Monte Carlo analyses is applied. In the solution space regions where the PWin is low, a smaller number of Monte Carlo trials and therefore evaluation fidelity is used. As the bid amount decreases and the PWin increases, a higher number of Monte Carlo trials and therefore solution fidelity is employed. This variable-fidelity meta-Monte Carlo approach ensures that the end user receives the most model accuracy in the portions they are most likely to rely on—the solution space with high PWin—but trades accuracy for runtime in solution space areas with low PWin and are therefore unlikely to be used in the decision-making process.

Best practices suggest the 85% probability of win point is sufficient for most competitions for most organizations. Higher values of PWin are typically used for highly strategically important competitions while lower values may be used for low strategic value, low risk, high reward situations. The price-to-win curve 710 is constructed from market pricing, strategic pricing, and competitor evaluation, each of which depends on a plurality of market conditions. Selecting a bid amount thus depends on strategic issues, current market conditions, and an assessment of competitors.

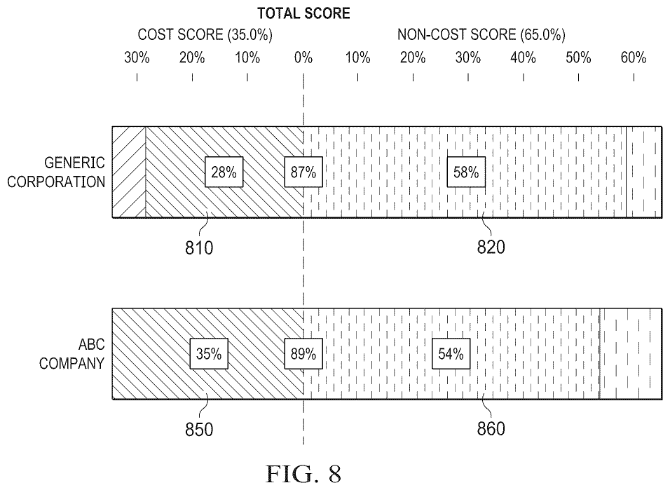

Turning now to FIG. 8, illustrated is a histogram illustrating an embodiment of cost score and non-cost score as components of a total score for one's own corporation (“generic corporation”) and a competitor (“ABC company”). FIG. 8 illustrates a comparison of multiple offerings after comprehending cost and non-cost factors and dictated by assumed rules of competition, in accordance with an embodiment. The generic corporation has a cost score 810 of 28% and a non-cost score 820 of 58% and the ABC company has a cost score 850 of 35% and a non-cost score 860 of 54%.

The total evaluated score is the overall weighted value index the evaluator uses to gauge which offer provides the best value. This includes both price and non-price considerations. It should be noted that this scoring system does not necessarily have to be explicit—i.e., the evaluator may not be actually calculating scores, however their likely behaviors are still able to be captured within the TruPredict system by a total scoring approach.

Cost score first takes the lowest bid amount across all competitors and divides by each bid's total evaluated price. The lowest bid is taken per each simulated competition—i.e., the lowest bid can be from a mix of companies, depending on uncertainty in their offering. This ratio will be equal to 1 when the current bid is the lowest bid, and will then decrease for all other bids. The pricing evaluation weight scales this ratio by how relatively important price is to the evaluator. This is an exemplary embodiment of cost score weighting, but other methods may be used.

$$Cost Score = ( Lowest Bid / Current Bid ) * Pricing Evaluation Weight$$

Non-cost score is simply a weighted sum or other aggregation method of each non-cost factor. These individual factors are in turn based on how an offering was rated qualitatively for each factor—this allows a series of assessments about each competitor's capabilities to ultimately roll up until on overall non-cost score.

The maximum available total score is the maximum cost score plus the maximum non-cost score-equal to 100%. The relative weights on the cost and non-cost factors will determine the mix between the two—i.e., if cost is weighted as 50% of the total score, the cost component cannot exceed 50% influence on the total score. All weights are specified during the client proposal process, such as Section M of US Government RFPs.

The TruPredict system inputs, analyzes and reports uncertainty through the use of Monte Carlo processing. Monte Carlo analysis is a mathematical approach to solving problems with uncertainty. Instead of inputs being represented by a single number, they are represented by a group of numbers that describe a distribution of outcomes. When combining variables with uncertainty, each input is independently distributed and then combined at random to form the resultant overall outcome. In contrast, a deterministic approach assumes each value is exactly known and that the relationship between variables never varies. When discussing future events with free-thinking competitors and evaluations, this is a particularly bad assumption.

Input are most often represented by three distinct points:
10th Percentile/Possible Low Value, the low outcome that happens 1 out of 10 times,
50th Percentile/Nominal/Base/Most Likely, the outcome that is the most expected, and
90th Percentile/Possible High Value, the high outcome that happens 1 out 10 times.

The TruPredict system takes these three points and creates a statistical distribution for each input, although other methods of creating uncertainty including Gaussian, step function, Poisson, among others are also comprehended. The distributions do not need to have any predetermined pattern-some inputs can have tight distribution, some can be very uncertain, some distributions can have symmetric upside/downside, someone can skew heavily either direction. The three points should reflect the reality of that input, either through data or estimates by informed stakeholders. Although it is suggested that input be treated as independent distributions, the concept of correlating inputs through a correlation matrix or some other means is also comprehended. Other numerical approaches to input and calculating uncertainty distributions are also comprehended.

It should be noted that the TruPredict system also applies to incremental Monte Carlo evaluation. When each input-contract pricing item, competitor evaluation, evaluation criteria weighting, etc.—is adjusted, the system is in real-time re-evaluating on the portion of the model that is used to reassess an overall evaluated price. This is in contrast to typical Monte Carlo implementations that employ a manual evaluation kickoff once all inputs have been specified. This real-time incremental evaluation offers more immediate feedback to the user on how individual or small input changes affect the overall output.

Some words have connotations of probability—i.e., possible equates to a roughly 1 in 10 likelihood; unlikely equates to a roughly 3 in 10 likelihood. These definitions can be used to elicit qualitative assessments into actual values for the probability of an event occurring. In other instances, qualitative assessments can be linked to outcomes through historical data or domain expertise—e.g., a tire that is judged “severely worn” has between 30-50% chance of a blowout in the next 1000 miles. This type of relationship is used within TruPredict's competitor evaluation to quantify subjective assessments.

The benefit of Monte Carlo analysis is that each contract line item, labor rate, part cost or other system input can have its own independent uncertainty. When combining these underlying variables into the total evaluated price and total evaluated score, the uncertainties interact in a non-linear fashion. Humans are very poor at inferring the impacts of compounding uncertainty-therefore, relying on the algorithm to combine uncertainties in a consistent approach is highly beneficial. This approach also captures the broad range of outcomes while still providing the user insight into how the result was generated.

In order to accelerate model execution time, those bid amounts with a low probability of win will use fewer Monte Carlo trials than those bid amounts with a higher probability of win. This mathematical approach is beneficial because offerors most often care about those bids that have a significant chance of winning—the TruPredict system spends more of its compute resources towards evaluating an accurate answers in these points of interest.

Once the TruPredict solution has canvased standard intervals between the 0% bid and 100% bid, any specific point of interest can be interpolated—for example, if an organization would like to hone their bid into a 95% probability of win, the TruPredict system will converge on that bid amount specifically even if it is not in the standard set of bid intervals. The TruPredict system displays a spline curve through all calculated bid amounts to provide a smooth function of probability of win vs. bid amount.

The TruPredict system also encompasses the ability to reverse engineer or reallocate pricing in order to secure a specific PWin. In this element the baseline price-to-win analysis is already formulated, the user dictates that targeted total evaluated price in order to secure an X % PWin, and then the reverse engineering element solves for the correct contract item pricing in order to meet that target. Bounds such as minimum, maximum, and fixed contract item costs among other approaches can be put in place to keep ensure that a realistic pricing structure is arrived at. The overall solution solver may be producing by stochastic optimization, linear algebra, numerical iteration, gross scaling or other mathematical convergence techniques known to those skilled in the art.

Also comprehended is a pricing analysis from the perspective of the customer. This is typically done when the end purchaser of the good or service has a fixed budget for acquisition. By incorporating the likely threshold for spending based on historical trends, analysis of departmental or divisional budgets, revenues, financial filing or other such means, a more realistic competitor evaluation approach can be formulated.

Once a competition has been awarded, the offering that won along with any known evaluation assessments/criteria can be input in the system to “learn” more about the tendencies of those entities involved in the competition. Learning may be done manually by means of a file lookup, automatically through some means of adaptive machine learning algorithm, or through other means.

Price-to-win is a multi-domain and subjective process filled with variation. Because there is no current system which provides an unambiguous framework for price-to-win analysis, a structured system is employed. The TruPredict system allows for a tool-enabled price-to-win process. It provides a single source to bring together contract details, pricing inputs, competitor evaluations, and competition evaluation criteria to produce a repeatable price-to-win estimate.

The TruPredict system increases the repeatability, increases the accuracy, and lowers the time to evaluate competitive bid scenarios. This allows for several improvements to an organization's processes such as the price-to-win analysis can be estimated earlier in the process to determine if a competition is worth pursuing or what broad price/performance will be needed to compete. The price-to-win practitioners can focus on collecting and refining high quality pricing and assessment data, instead of on how to structure more generic analytics systems. “What-if” scenarios can be produced in a matter of minutes. This allows for a fluid conversation around strategies and counter-strategies. The consumers of the price-to-win analyses receive standardized outputs with a traceable flow from input data to final result.

The TruPredict system allows for a more accurate, repeatable calculation of an organization's price-to-win. This allows for more informed bids, faster win strategy development, more understanding of your competition and ultimately, a higher probability of winning competitive bids. The methods described here use many sellers bidding to a single buyer, but these methods apply to any economic competition with auction attributes.

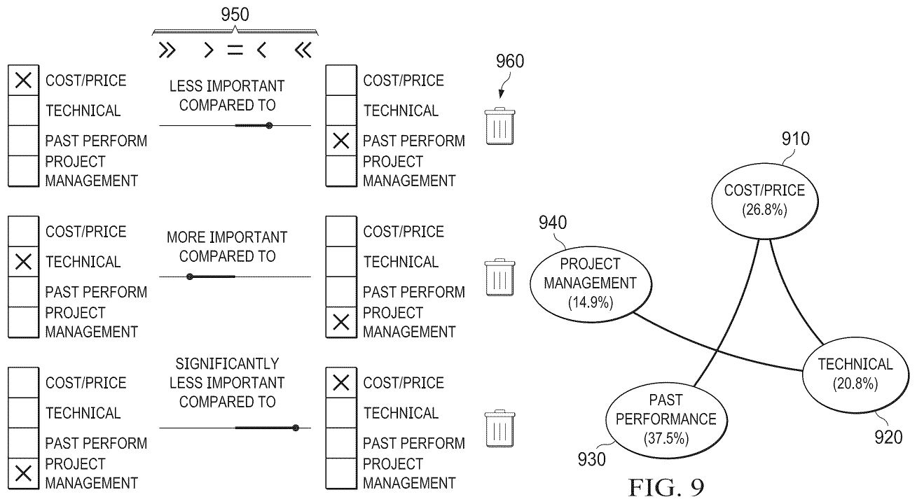

Turning now to FIG. 9, illustrated is a diagram showing an embodiment of receiving qualitative statements relating to non-cost factors. For instance, cost/price is less important compared to past performance. The technical competence or performance is more important compared to project management. The project management is significantly less important than cost/price. The diagram with the circles and connecting lines provide a mathematically coherent process to quantify the relationships into a series of relative weighting for customer evaluation. FIG. 9 illustrates an automated process for decomposing natural language into quantitative values for competitive evaluation criteria. Each evaluation criterion is mentioned in a comparative at least once. The automated process validates that no statement logically contradicts another statement before proceeding. The illustrated embodiment is an example of an approach to quantify evaluation importance, and other methods are comprehended.

As mentioned above, cost/price is judged to be less important than past performance. Technical competence is judged to be more important than project management. Project management is judged to be significantly less important than cost/price. In essence, a series of verbal statements is used to derive the overview drawing. The area 910 is a visual representation of relative weightings for cost/price. The area 920 is a visual representation of relative weightings for technical competence. The area 930 is a visual representation of relative weightings for past performance. The area 940 is a visual representation of relative weightings for project management capability. The percentages represent relative weightings for the different criteria that result from positioning the sliders 950 illustrated in the left portion of FIG. 9. FIG. 9 thus shows a process to quantify the assessments illustrated at the left side of FIG. 9. The quantified assessments can be based on historical experiences. The trash cans 960 in the central portion of FIG. 9 represent setting data to zero at the beginning of a bid assessment.

Within the exemplary approach, the series of defined language statements have been used to derive the bubble diagram at the right, i.e., language statements are translated into a parallel series of linear algebraic equations. The sliders 950 are adjusted to control importance or lack of importance of the particular characteristics, i.e., cost/price, technical competence, past performance, and project management. Once the series of equations has a definable solution—i.e. the system has the correct number of relationships defined; no relationships cause a circular logic error-a quantified weighting schema can he output and optionally adjusted per the user's preference. These equations also encompass evaluation criteria that exist within a hierarchy—for example, technical performance for an aircraft is a criteria that is comprised of vehicle speed, vehicle range, and vehicle payload.

Other methods of determining overall value based on non-cost factors are also comprehended—e.g., technical performance above and beyond the baseline requirement reflecting a better value to the customer even if it is offered at a higher price. This approach has been referred to as VATEP by some US government agencies, however other methods for influencing effective cost through non-cost performance are also comprehended.

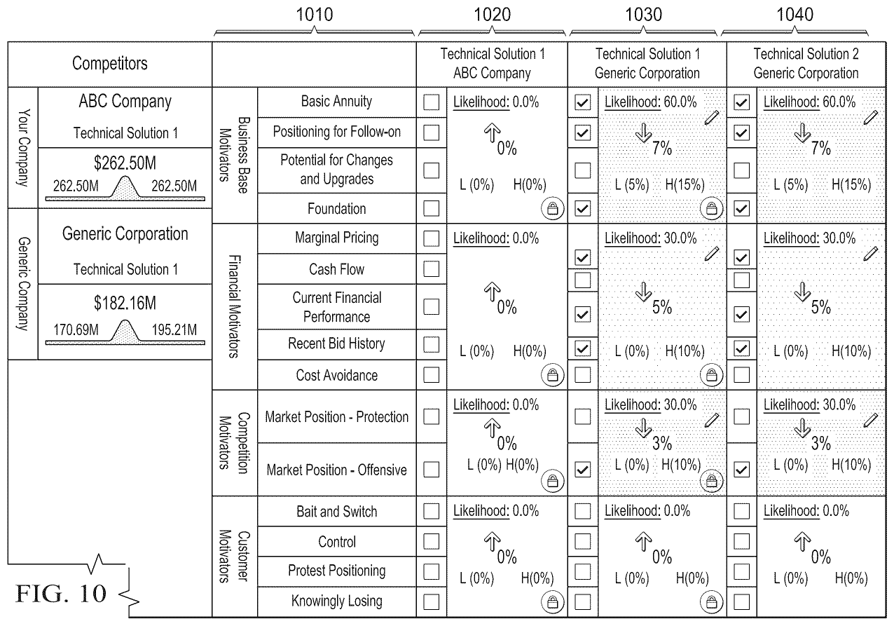

Turning now to FIG. 10, illustrated is a screenshot showing an overview of strategic pricing motivators represented on a dashboard which can be comprehended and addressed quantitatively to a competitive bid. Each competitor (e.g., ABC company and generic corporation) is assessed based on their likely tendency to react to defined motivators 1010. The exemplary motivators, such as technical solution 1 1020 for ABC company and technical solutions 1 and 2 1030, 1040, respectively, for generic corporation, are based on experience as price-to-win practitioners, consultants, competitive bidders, and as contract evaluators. Other embodiments with different motivators and different broad motivational categories are also comprehended.

At each intersection of motivation and competitor offering, an assessment is made of the likelihood of a pricing change action as well as the magnitude of that price change effect. This most often represents the percentage discount an organization will make to their market price due to a specific business motivator, e.g., such as expected annuity for the project. In such a situation, short-term losses can be discounted in view of future long-term gains. Other approaches for quantifying probabilistic or deterministic discounting actions are also comprehended.

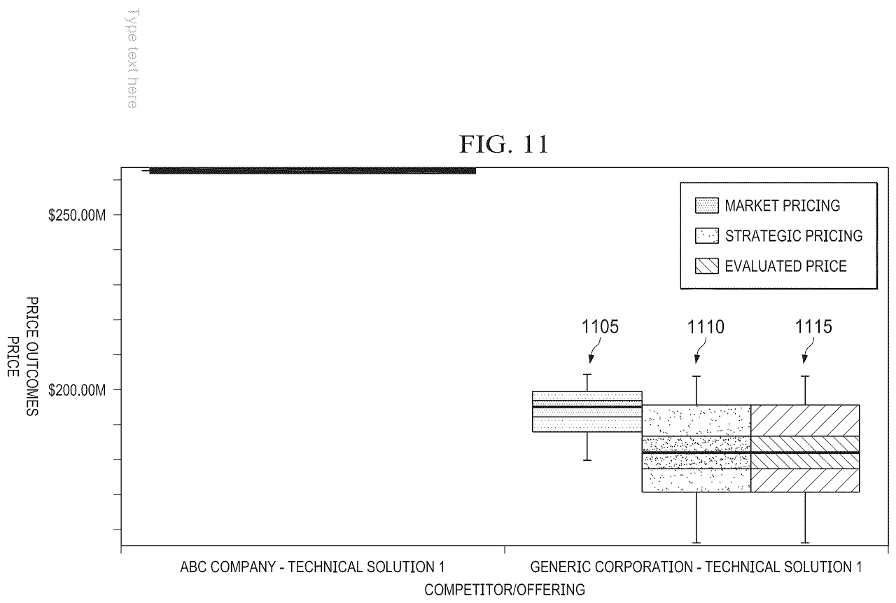

Turning now to FIG. 11, illustrated is a graphical representation showing example price outcomes of two competitors for a given bid amount, after being assessed through the TruPredict system. FIG. 11 illustrates a process by which prices of multiple offerings can be compared after considering strategic pricing initiatives and value-based price adjustments.

An ABC company market pricing is shown at 1105 and a generic corporation strategic pricing is shown at 1110 to produce an evaluated price shown at 1115. The system comprehends a range of price outcomes after each of the major steps—market pricing, strategic pricing, and competitor evaluation as described hereinabove with reference to FIGS. 2 through 6. The shaded regions and outer error bars represent the percentile functions of that result—i.e. the variation or uncertainty in that result. The variability of each price is the representation of mathematical methods for combining uncertain variables, such as Monte Carlo analysis. Other methods for visualizing and communicating results with uncertainty for a competitor's evaluated price are also comprehended.

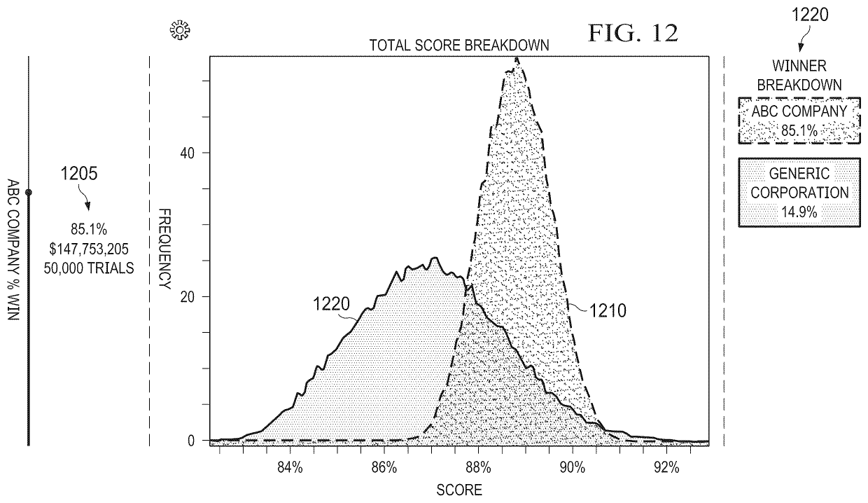

Turning now to FIG. 12, illustrated are curves representing example probabilistic outcomes of two competitive offerings for a given bid amount. The curves represent total score comparison of multiple competitors for a given bid amount. The total score breakdown for a given offering can be broken down into its constituent elements. This information can be displayed in a Sankey diagram, tree-diagram, influence diagram, histogram, box-and-whisker plot or other data visualization technique meant to display nested data relationships. The key information contained within such an element is most likely the value of the overall score, the probability distribution of the overall score, the percentile values of the overall score, the source of sensitivity in the overall score, the sources of uncertainty in the overall score, and the relative relationship between the underlying contract items/evaluation criteria on both sensitivity and uncertainty.

The probability of win (“PWin”) for the designated organization ABC Company (represented by curve 1210) and generic corporation (represented by curve 1210) is the independent variable (selected at the left) while the outcomes of total score for each organization, as well as the probability of win for each organization are displayed at the right. As the ABC company bids a higher amount, the curve 1210 shifts to the left, reflecting a lower overall competition score and thus a lower win probability. As the generic corporation bids a lower amount, the curve 1220 shifts to the right, reflecting a higher overall competition score and thus a higher win probability. As the PWin is varied (and correspondingly, the bid amount) the range of outcomes in total score for each competitor will change. The non-cost score for each competitor remains the same; however, the cost score is directly impacted by the shifting bid amount. Other embodiments for communicating the dynamic range of total score outcomes for competitors/offers within a competition are also comprehended.

The graphical representation illustrated in FIG. 12 indicates a bid of $147,753,205 would be expected to win 85.1% of the time, as determined by an example Monte Carlo run of 50,000 trials. At this bid price generic corporation would be expected to win the other 14.9% of the time. Although FIG. 12 depicts a competition between two competitors, the proposed system comprehends competitions with a multitude competitors and competitor offerings that can be quantitatively compared against each other with the same methods described.

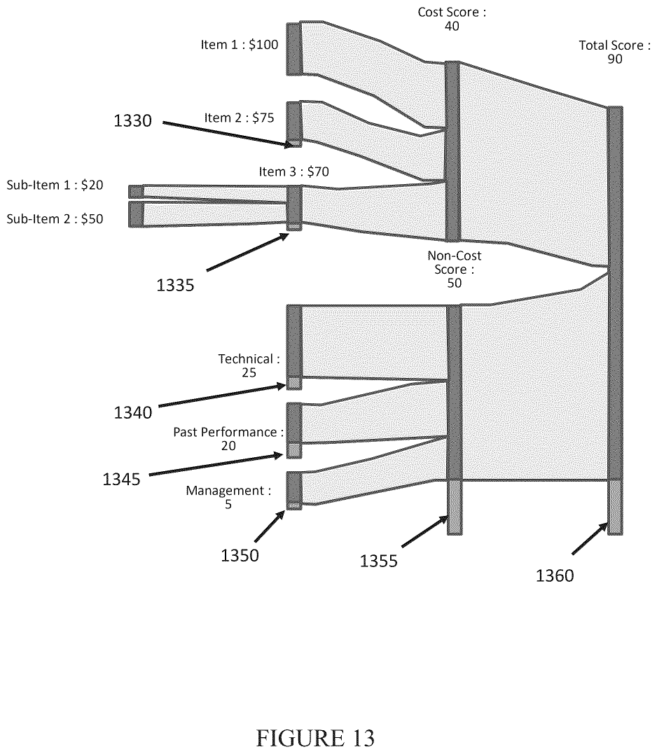

Turning now to FIG. 13, illustrated is an example of decomposition backward of total offering score into its constituent parts. FIG. 13 illustrates total score of 90 for a given offering broken down into its constituent elements. This information can be displayed in a Sankey diagram, tree-diagram, influence diagram or other data visualization technique meant to display nested data relationships. The key information contained within such an element is the source of sensitivity in the overall score, the sources of uncertainty in the overall score, and the relative relationship between the underlying contract items (sub-item 1 and sub-item 2)/evaluation criteria (technical competence, past performance and management) on both sensitivity and uncertainty, and cost and non-cost basis. Other information such as influence relative to a maximum contribution shown in the areas (such as areas 1330, 1335, 1340, 1345, 1350, 1355, 1360) in FIG. 13 are also comprehended. The primary purpose of the embodiment above is to provide context to the user and direct further analysis within the system.

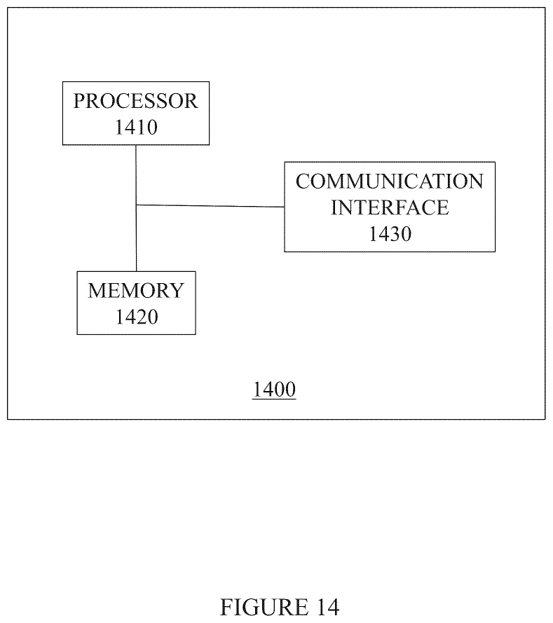

Turning now to FIG. 14, illustrated is a schematic view of an embodiment of at least a portion of an apparatus 1400 employable to run the TruPredict system. The apparatus includes a processor 1410 that may execute example machine-readable instructions to implement at least a portion of one or more of the methods and/or processes described herein, and/or to implement producing a bid for an offering. The apparatus may be a, for example, controller, special-purpose computing device, server, personal computer, personal digital assistant (“PDA”) device, smartphone, tablet, internet appliances, and/or other types of computing devices.

The apparatus 1400 includes the processor 1410 such as, for example, a general-purpose programmable processor. The apparatus 1400 includes a memory 1420, and may execute coded instructions present in the memory 1420 and/or another memory device. The processor 1410 may execute, among other things, machine-readable instructions or programs to implement the methods and/or processes described herein. The programs stored in the memory 1420 may include program instructions or computer program code that, when executed by an associated processor, enable the apparatus 1400 to perform tasks as described herein. The processor 1410 may be implemented by one or a plurality of processors of various types suitable to the local application environment, and may include one or more of general or special-purpose computers, microprocessors, digital signal processors (“DSPs”), field-programmable gate arrays (“FPGAs”), application-specific integrated circuits (“ASICs”), and processors based on a multi-core processor architecture, as non-limiting examples. Other processors from other families are also appropriate.

The processor 1410 may be in communication with memory 1420, such as may include a volatile memory and a non-volatile memory, perhaps via a bus and/or other communication means. The volatile memory may be implemented by random access memory (“RAM”), static random access memory (“SRAM”), synchronous dynamic random access memory (“SDRAM”), dynamic random access memory (“DRAM”), RAMBUS dynamic random access memory (“RDRAM)” and/or other types of random access memory devices. The memory 1420 may be implemented by read-only memory, flash memory and/or other types of memory devices. One or more memory controllers (not shown) may control access to the memory 1420.

The apparatus also includes a communication interface circuit 1430. The communication interface circuit 1430 may be implemented by various types of standard interfaces, such as an Ethernet interface, a universal serial bus (“USB”) interface, a wireless interface, and/or a cellular interface, among others. The communication interface circuit 1430 may also include a graphics driver card. The communication interface circuit 1430 may also include a device such as a modem or network interface card to facilitate exchange of data with external computing devices via a network (e.g., Ethernet connection, digital subscriber line (“DSL”), telephone line, coaxial cable, cellular telephone system, satellite, etc.).

One or more input devices may be connected to the communication interface circuit 1430. The input device(s) may permit a user to enter data and commands into the processor 1410. The input device(s) may be, comprise, or be implemented by, for example, a keyboard, a mouse, a touchscreen, a track-pad, a trackball, an isopoint, and/or a voice recognition system, among others. The input device(s) may comprise an image-capturing device configured to capture an image or video and provide visual content.

One or more output devices may also be connected to the communication interface 1430. The output devices may be implemented by, for example, display devices (e.g., a liquid crystal display or cathode ray tube display (“CRT”), among others), printers, and/or speakers, among others.

The apparatus 1400 may also include one or more mass storage devices for storing machine-readable instructions and data. Examples of such mass storage devices include floppy disk drives, hard drive disks, compact disk (“CD”) drives, and digital versatile disk (“DVD”) drives, among others. The coded instructions may be stored in the memory 1420, which can be formed with local memory, and/or on a removable storage medium, such as a CD or DVD. Thus, the modules and/or other components of the apparatus 1400 may be implemented in accordance with hardware (embodied in one or more chips including an integrated circuit such as an ASIC), or may be implemented as software or firmware for execution by a processor. In particular, in the case of firmware or software, the embodiment can be provided as a computer program product including a computer readable medium or storage structure embodying computer program code (i.e., software or firmware) thereon for execution by the processor.

Thus, an apparatus and a related method configured to aggregate market pricing, strategic pricing, and competitor evaluation to produce a bid price for an offering to win a competition within a confidence interval has been introduced. In an embodiment, the market pricing is determined for an offering derivable from a labor pricing model to estimate a cost of a service, or derivable from a bill of materials model to estimate a cost of a good. In an embodiment, the strategic pricing is determined for an offering derivable from a likelihood of an action being taken and a magnitude of a pricing change if that action occurs. In an embodiment, a competitor evaluation is determined for the offering capturing a view of the customer towards each competitive offering along factors that may incorporate factors beyond solely cost.

As described hereinabove, the exemplary embodiments provide both a method and corresponding apparatus consisting of various modules providing functionality for performing the steps of the method. The modules can be implemented as hardware (embodied in one or more chips including an integrated circuit such as an application specific integrated circuit), or can be implemented as software or firmware for execution by a processor. In particular, in the case of firmware or software, the exemplary embodiments can be provided as a computer program product including a computer readable storage medium embodying computer program code (i.e., software or firmware) thereon for execution by the computer processor. The computer readable storage medium can be non-transitory (e.g., magnetic disks; optical disks; read only memory; flash memory devices; phase-change memory) or transitory (e.g., electrical, optical, acoustical or other forms of propagated signals-such as carrier waves, infrared signals, digital signals, etc.). The coupling of a processor and other components is typically through one or more busses or bridges (also termed bus controllers). The storage device and signals carrying digital traffic respectively represent one or more non-transitory or transitory computer readable storage medium. Thus, the storage device of a given electronic device typically stores code and/or data for execution on the set of one or more processors of that electronic device such as a controller.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same can be reordered, omitted, added, etc., and still fall within the broad scope of the various embodiments.

Moreover, the scope of the various embodiments is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized as well. Accordingly, the appended claims are intended to include within their scope such processes, machines, manufacture, compositions of matter, means, methods, or steps

1. A method operating on a processor and memory, comprising:
receiving a request for proposal from an external system;
interpreting said request for proposal to determine a scope of and evaluation criteria for said request for proposal;
breaking down said scope of said request for proposal into constituent parts by a first line item and a second line item including dynamic links therebetween;
producing an offering to said request for proposal, comprising:
determining market price of said offering, comprising:
selecting a market pricing model,
selecting a first range of prices for said first line item,
selecting a second range of prices for said second line item,
independently distributing and randomly combining said first range of prices with said second range of prices to produce a random distribution of prices, and
applying said random distribution of prices to said market pricing model to produce a plurality of market prices,
determining strategic pricing of said offering including market price adjustments of a competitor,
determining a competitor evaluation score of said offering including a qualitative ranking value of said competitor based on said evaluation criteria,
producing a plurality of bid prices for said offering within a confidence interval of a probability of winning a competition by independently distributing and randomly combining said plurality of market prices with said strategic pricing and said competitor evaluation score, calculation of said plurality of bid prices being bounded to said confidence interval to improve a computational efficiency and evaluation runtime of said processor, and
selecting of final bid price for said offering in accordance with said evaluation criteria from said plurality of bid prices at a confidence interval level within said confidence interval; and
reporting said offering directing a decision-maker to use said final bid price for said competition to said external system.

2. The method as recited in claim 1 further comprising periodically receiving updates to said request for proposal.

3. The method as recited in claim 1 wherein said first line item represents a cost of a service of said offering and said second line item represents a cost of a good of said offering.

4. The method as recited in claim 1 wherein said strategic pricing includes market price adjustments of a plurality of competitors and said competitor evaluation score includes a qualitative ranking value of said plurality of competitors based on said evaluation criteria.

5. The method as recited in claim 1 wherein said producing said offering further comprises providing a graphical representation of a price-to-win curve of said probability of winning said competition for said plurality of bid prices within said confidence interval.

6. The method as recited in claim 1 wherein said strategic pricing includes a magnitude and range of said market price adjustments based on likely actions by and discount tendencies of said competitor.

7. The method as recited in claim 6 wherein said likely actions by and discount tendencies of said competitor are based on competitive intelligence of said competitor.

8. The method as recited in claim 1 wherein said competitor evaluation score includes a range of competitor evaluation scores of said competitor.

9. The method as recited in claim 1 wherein said confidence interval level is set at 85 percent probability of winning said competition.

10. The method as recited in claim 1 wherein said final bid price for said offering is broken down and reported by said first line item and said second line item.

11. A system, comprising:
a processor and memory, configured to:
receive a request for proposal from an external system;
interpret said request for proposal to determine a scope of and evaluation criteria for said request for proposal;
break down said scope of said request for proposal into constituent parts by a first line item and a second line item including dynamic links therebetween;
produce an offering to said request for proposal, comprising:
determine market price of said offering, comprising:
select a market pricing model,
select a first range of prices for said first line item,
select a second range of prices for said second line item,
independently distribute and randomly combine said first range of prices with said second range of prices to produce a random distribution of prices, and
apply said random distribution of prices to said market pricing model to produce a plurality of market prices,
determine strategic pricing of said offering including market price adjustments of a competitor,
determine a competitor evaluation score of said offering including a qualitative ranking value of said competitor based on said evaluation criteria,
produce a plurality of bid prices for said offering within a confidence interval of a probability of winning a competition by independently distributing and randomly combining said plurality of market prices with said strategic pricing and said competitor evaluation score, calculation of said plurality of bid prices being bounded to said confidence interval to improve a computational efficiency and evaluation runtime of said processor, and
select of final bid price for said offering in accordance with said evaluation criteria from said plurality of bid prices at a confidence interval level within said confidence interval; and
report said offering directing a decision-maker to use said final bid price for said competition to said external system.

12. The system as recited in claim 11 wherein said processor and said memory are further configured to periodically receive updates to said request for proposal.

13. The system as recited in claim 11 wherein said first line item represents a cost of a service of said offering and said second line item represents a cost of a good of said offering.

14. The system as recited in claim 11 wherein said strategic pricing includes market price adjustments of a plurality of competitors and said competitor evaluation score includes a qualitative ranking value of said plurality of competitors based on said evaluation criteria.

15. The system as recited in claim 11 wherein said processor and said memory are further configured to provide a graphical representation of a price-to-win curve of said probability of winning said competition for said plurality of bid prices within said confidence interval.

16. The system as recited in claim 11 wherein said strategic pricing includes a magnitude and range of said market price adjustments based on likely actions by and discount tendencies of said competitor.

17. The system as recited in claim 16 wherein said likely actions by and discount tendencies of said competitor are based on competitive intelligence of said competitor.

18. The system as recited in claim 11 wherein said competitor evaluation score includes a range of competitor evaluation scores of said competitor.

19. The system as recited in claim 11 wherein said confidence interval level is set at 85 percent probability of winning said competition.

20. The system as recited in claim 11 wherein said final bid price for said offering is broken down and reported by said first line item and said second line item.
